(19) United States
(12) Patent Application Publication
(10) Pub. No.: US 2004/0161539 A1
(43) Pub. Date: Aug. 19, 2004

(54) Method and apparatus for forming porous insulating layer and electronic device manufactured using the method

(76) Inventor: Takuya Miyakawa, Okaya City (JP)

Correspondence Address: HARNESS, DICKEY & PIERCE, P.L.C., P.O. BOX 828, BLOOMFIELD HILLS, MI, 48303, US

(21) Appl. No.: 10/680,564

(22) Filed: Oct. 7, 2003

(30) Foreign Application Priority Data
Oct. 15, 2002 (JP) 2002-300183
Oct. 1, 2003 (JP) 2003-343329

(51) Int. Cl. B05D 3/02

(52) U.S. Cl. 427/376.2; 118/50

(57) ABSTRACT

A porous insulating layer-forming apparatus includes a solution-applying portion, a solidified layer-forming portion, a vacuum drying portion, a firing portion, and an airtight treatment portion. The solution-applying portion applies a solution in which an insulating material is dissolved, onto a workpiece. In the solidified layer-forming portion, a cooling plate cools the solution applied onto the workpiece to a temperature less than or equal to the melting point of the solvent in the solution to yield a solidified layer. In the vacuum drying portion, a decompression chamber is decompressed by a vacuum pump to vaporize the solvent in the solidified layer, thereby changing the solidified layer into a porous solidified layer. In the firing potion, the porous solidified layer is hardened by firing on a hot plate to yield a porous insulating layer. In the airtight portion, heat rays emitted from a flushing device instantaneously irradiate the surface of the porous insulating layer to melt the surface to cover the pores in the surface, thereby giving the porous insulating layer airtightness.

### FIELD OF THE INVENTION

The present invention relates to a method for forming an insulating layer with a low dielectric constant suitably used for an interlayer insulating layer of a large-scale integration (LSI) circuit. In particular, the invention relates to a method and an apparatus for forming a porous insulating layer with a large number of pores, and to an electronic device manufactured by the method.

### BACKGROUND OF THE INVENTION

Electronic devices such as semiconductor devices have undergone operational speed enhancement, downsizing, and larger scale integration. As such, a number of elements are stacked in layers. Further, in order to achieve a downsized, highly integrated semiconductor device, each element is miniaturized, and the distances between wires and the widths of interlayer insulating layers for electrically insulating the respective wires are reduced. However, a small width (gap) of an interlayer insulating layer increases the capacitance of the interlayer insulating layer and interferes with high-speed operation of a semiconductor device. Accordingly, the use of a material with a low dielectric constant (so-called Low-k material) has been studied for the interlayer insulating layer. That is, to reduce the dielectric constant of the interlayer insulating layer, a method has been proposed in which the interlayer insulating layer is formed of mesoporous silica.

Recent semiconductor devices are multi-layered to be highly integrated and to enhance performance. The interlayer insulating layer for insulating wires of layers from each other is flattened by applying a mesoporous silica solution or liquid borophosphosilicate glass (BPSG) and subsequently heating the applied liquid to be hardened. FIG. 5 is a fragmentary schematic sectional view of a semiconductor device having such interlayer insulating layers.

In FIG. 5, a semiconductor device 150 includes a MOS transistor 154 on a semiconductor substrate 152. The MOS transistor 154 includes a gate electrode 160 on a gate oxide layer 156 provided on the surface of the semiconductor substrate 152. The MOS transistor 154 also has a source 162 and a drain 164 disposed at both sides of the gate electrode 160. The MOS transistor 154 is covered with a first interlayer insulating layer 166 formed of BPSG or the like. The first interlayer insulating layer 166 is provided with lower wires 168 on the upper surface thereof. The lower wires 168 are electrically connected to the source 162 and drain 164 of the MOS transistor 154 through via holes passing through the first interlayer insulating layer 166.

A second interlayer insulating layer 170 is provided on the upper surface of the first interlayer insulating layer 166 to cover the lower wires 168. The second interlayer insulating layer 170 is formed by spin-coating, for example, BPSG, as with the first interlayer insulating layer 166, and subsequently heating to a temperature of about 900° C. to be hardened. The second interlayer insulating layer 170 is provided with upper wires 172 on the upper surface thereof. The upper wires 172 are electrically connected to the lower wires 168 through via holes passing through the second interlayer insulating layer 170.

Unfortunately, the method for forming an interlayer insulating layer disclosed in Japanese Unexamined Patent Application Publication No. 2002-53773 requires many and complicated steps of: (1) synthesizing ultrafine-particle mesoporous silica; (2) separating and recovering the ultrafine-particle mesoporous silica; (3) surface-treating the ultrafine-particle mesoporous silica; (4) preparing an application liquid by dissolving the ultrafine-particle mesoporous silica in a solvent; (5) applying the application liquid onto a workpiece; and (6) heating the application liquid to dry. Thus, the method disclosed in Japanese Unexamined Patent Application Publication No. 2002-53773 requires a lot of time and effort to form an interlayer insulating layer.

In addition, if the interlayer insulating layer is formed by applying a liquid insulating material, such as BPSG, as described above, the liquid insulating material is shrunk in a heating and hardening step. As a result, as seen from the second interlayer insulating layer 170 in FIG. 5, for example, the presence of the lower wires 168 makes the surface of the second interlayer insulating layer 170 uneven. The same goes for the formation of the first interlayer insulating layer 166 and other interlayer insulating layers formed of mesoporous silica solution. Consequently, it is impossible to flatten the surface of the interlayer insulating layer only by applying a liquid insulating material and subsequently heating the material to harden it. Thus, the unevenness at the surface of the interlayer insulating layer makes it difficult to form a fine pattern with high precision. Accordingly, the surface has to be planarized by chemical mechanical polishing (CMP) as with, for example, the first interlayer insulating layer 166 shown in FIG. 5. Therefore, the known method includes a complicated process and thus requires a lot of time to planarize the surface of the interlayer insulating layer.

### SUMMARY OF THE INVENTION

The present invention is intended to overcome the above-described problems, and an object of the present invention is to facilitate the formation of a porous insulating layer. Another object of the present invention is to facilitate the formation of an insulating layer with a low dielectric constant. Still another object of the present invention is to facilitate the planarizaition of the surface of an interlayer insulating layer.

In order to accomplish the above objects of the invention, a method for forming a porous insulating layer includes applying a solution in which an insulating material is dissolved onto a workpiece; forming a solidified layer by cooling the solution applied onto the workpiece to a temperature less than or equal to the melting point of a solvent contained in the solution; removing the solvent contained in the solidified layer to make the solidified layer porous; and hardening the dried porous solidified layer.

In the present invention, a solution in which an insulating material, such as fine particles of silicon dioxide (SiO₂) or tetraethoxysilane (TEOS), is dissolved is applied onto a workpiece, and is subsequently cooled to a temperature less than or equal to the melting point of the solvent to solidify (i.e., freeze) the solution into a solidified layer. Then, the solidified layer is dried to remove the solvent, and, thus, the layer becomes porous. Lastly, the solidified layer is fired to yield a porous insulating layer. In other words, the porous insulating layer can be easily formed through a few steps, in a relatively short time. Furthermore, freeze-drying of the solution allows a large number of pores (air holes) to be produced in the insulating layer. Thus, the porosity can be increased to 90% or more, and accordingly the resulting insulating layer exhibits a very low dielectric constant. In addition, the applied solution is freeze-dried to form the porous insulating layer. This allows the solution to fill unevenness, if any, on the surface of the workpiece. Thus, the surface of the workpiece is flattened in parallel with the formation of the porous insulating layer.

Preferably, in the solution-applying step, the solution is applied so as to cover the unevenness of the surface of the workpiece to flatten the surface of the applied layer. The solution applied to cover the unevenness on the surface of the workpiece is formed into a solid (solid state), such as a gel, maintaining the shape right after the solution is applied, when cooled to a temperature less than or equal to the melting point of the solvent. By drying the material in a solid state, while being allowed to stand at a temperature less than or equal to the melting point of the solvent, a porous insulating layer with an even surface can be easily provided even if the workpiece has an uneven surface. Thus, an insulating layer with an even surface can be obtained by firing this porous layer. Therefore, a polishing step, such as CMP, is not required to planarize the surface of the insulating layer. Consequently, the process can be simplified, and the time for forming an insulating layer with an even surface can be reduced.

Preferably, the drying step is performed under a reduced pressure. Drying under a reduced pressure (i.e., vacuum drying) significantly reduces the time for drying. The solidified layer-forming step may be performed after part of the solvent is removed from the solution applied onto the workpiece. The solidified layer obtained by freezing the solution has substantially the same thickness as that of the solution right after being applied. Therefore, by vaporizing part of the solvent in the solution before forming the solidified layer, the thickness of the coating layer of the solution can be reduced to adjust the thickness of the solidified layer, that is, the porous insulating layer.

Preferably, the firing step is followed by airtight treatment for eliminating the air permeability of the hardened porous solidified layer. A porous insulting layer formed by so-called freeze drying has a very high porosity and, accordingly, often exhibits air permeability between one surface of the layer and the other surface if the layer has a small thickness. Consequently, the porous insulating layer exhibits continuity or its insulation properties is degraded due to water trapped in the layer from the air. Accordingly, the air permeability of the hardened porous solidified layer (porous insulating layer) is eliminated by air treatment after firing. Thus, the insulation properties of the porous insulating layer are prevented from deteriorating. Specifically, the surface of the porous insulating layer is instantaneously exposed to high temperature by using a flushing device or a laser to melt the surface thereof, and thus, the pores in the surface are covered.

The solidified layer-forming step may be performed by rapidly cooling the solution. If the solvent of the solution has a low melting point, cooling prevents variation in layer pressure resulting from vaporization (evaporation) of the solvent. Thus, the resulting solidified layer has a desired thickness. Preferably, the application of the solution onto the workpiece is performed by slit coating. Slit coating increases the utilization efficiency of the solution because the solution is discharged in such a manner as to exude from a miniature nozzle or nozzles at small intervals by the capillary phenomenon.

A porous insulating layer-forming apparatus of the present invention includes a solution-applying portion for applying a solution in which an insulating material is dissolved onto a workpiece; a solidified layer-forming portion for cooling the solution applied onto the workpiece to a temperature less than or equal to the melting point of the solvent contained in the solution to form a solidified layer; a vacuum drying portion for removing the solvent contained in the solidified layer to make the solidified layer porous by decompression; and a firing portion for hardening the dried porous solidified layer. Thus, the porous insulating layer can be easily formed with reliability. The solidified layer-forming portion may be provided inside a decompression chamber of the vacuum drying portion. Thus, the apparatus can be downsized and the process can be simplified.

An electronic device of the present invention includes a porous insulating layer formed by the foregoing method for forming a porous insulating layer. Thus, the resulting electronic device, such as a semiconductor device or a liquid crystal panel, achieves the above-described effects.

### BRIEF DESCRIPTION OF THE DRAWINGS

FIG. 1 is a schematic representation of the structure of a porous insulating layer-forming apparatus according to an embodiment of the present invention;

FIG. 2 is representations of a process for applying a solution according to an embodiment of the present invention;

FIG. 3 is a flow chart of a process for forming a porous insulating layer according to an embodiment of the present invention;

FIG. 4 is a fragmentary schematic sectional view of an electronic device according to an embodiment of the present invention; and

FIG. 5 is a fragmentary schematic sectional view of a known electronic device.

### DETAILED DESCRIPTION OF THE PREFERRED EMBODIMENTS

A method and an apparatus for forming a porous insulating layer of the present invention and an electronic device manufactured the method will now be illustrated in detail with reference to the accompanying drawings. Elements described in the description of the prior art are designated by the same reference numerals and the description is not repeated.

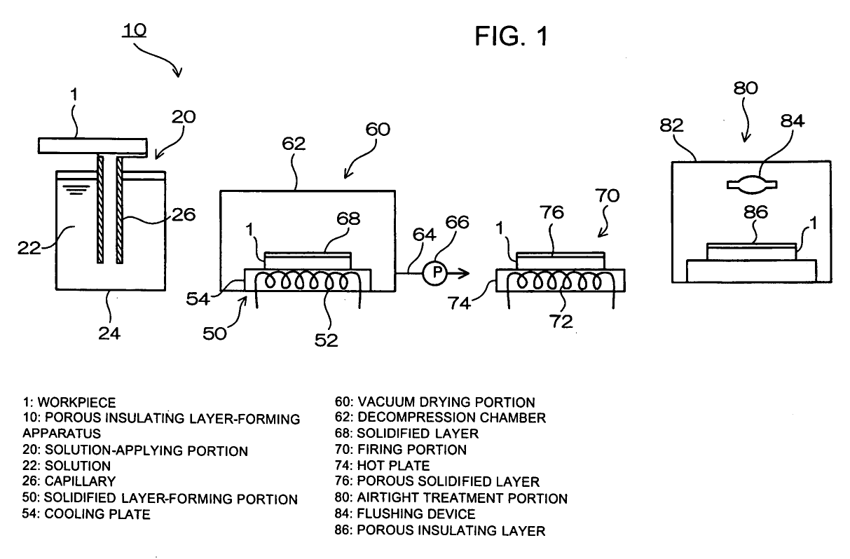

FIG. 1 is a schematic representation of the structure of a porous insulating layer-forming apparatus of the present invention. In FIG. 1, the porous insulating layer-forming apparatus 10 has a solution-applying portion 20. The solution-applying portion 20 includes an application liquid bath 24. The application liquid bath 24 contains a solution 22 in which an insulating material, such as fine silicon dioxide powder or an alkoxide compound, is dissolved. The solution 22 in the application liquid bath 24 is applied onto a workpiece 1, such as a semiconductor substrate or a glass substrate, from a capillary 26 that is an application nozzle.

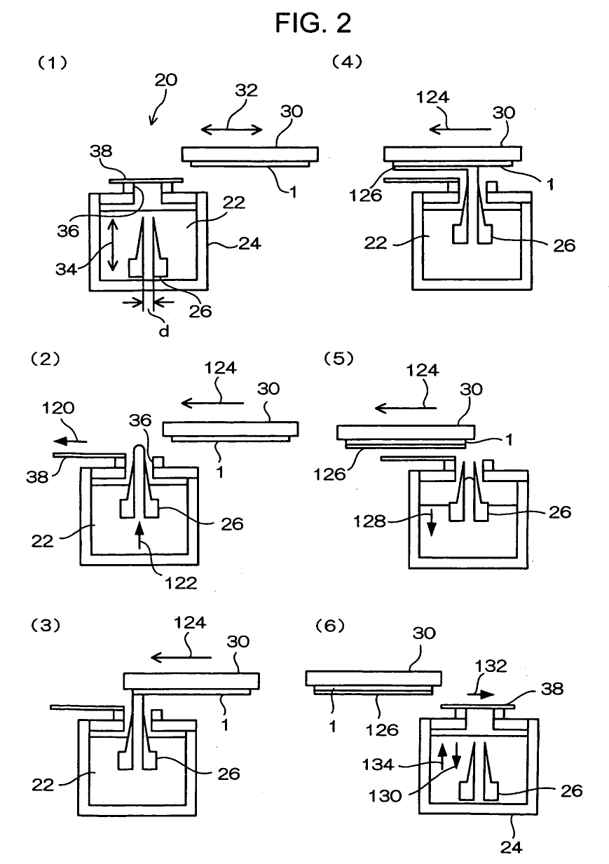

More specifically, the solution-applying portion 20 has a chuck 30 for holding the workpiece 1 by vacuum suction, as shown in FIG. 2(1). The chuck 30 can move in the horizontal direction of FIG. 2 as designated by arrow 32. The workpiece 1 is held by the bottom surface of the chuck 30 and, thus, the chuck 30 allows the workpiece 1 to pass over the application liquid bath 24. The capillary 26 can move in the vertical direction, as designated by arrow 34, to sink in the solution 22 during standby. The capillary 26 is formed in a slit manner whose longitudinal direction is perpendicular to the face of FIG. 2, and has a length larger than the width of the workpiece 1.

A freely closable cover 38 is disposed on an opening 36 at the top of the application liquid bath 24. The cover 38 prevents the solvent of the solution 22 in the application liquid bath 24 from vaporizing and thus prevents changes in concentration of the solution 22. The capillary 26 moves such that the leading edge (top) thereof rises from the top opening 36 of the application liquid bath 24. The opening width d of the capillary 26 is 5 to 6 μm, and discharges the solution 22 by a capillary phenomenon. In other words, the solution-applying portion 20 uses a slit coating method to apply the solution 22 onto the workpiece 1. However, the solution 22 may be applied onto the workpiece 1 by spin coating, brush coating, or dipping.

The porous insulating layer-forming apparatus 10 includes a solidified layer-forming portion 50, a vacuum drying portion 60, a firing portion 70, and an airtight treatment portion 80, as shown in FIG. 1. The solidified layer-forming portion 50 of the embodiment includes a metallic cooling plate 54 having a cooling coil 52. The cooling plate 54 rapidly cools the solution 22 applied onto the workpiece 1 to a temperature lower than or equal to the melting point of the solvent to form a gel solidified layer 68. The vacuum drying portion 60 has a decompression chamber 62 in which the workpiece 1 is placed. The decompression chamber 62 is intended to make the gel solidified layer 68 porous by freeze-vacuum drying, and is connected to a vacuum pump 66 through an exhaust pipe 64. Hence, by operating the pump 66, the decompression chamber 62 is evacuated to produce a vacuum. For the embodiment, the solidified layer-forming portion 50 is put inside the decompression chamber 62 of the vacuum drying portion 60. This structure reduces the size of the apparatus and simplifies the step of conveying the workpiece 1. The solidified layer-forming portion 50 may of course be provided outside the decompression chamber 62.

The firing portion 70 of the embodiment comprises a hot plate 74 containing a heater 72. However, the firing portion 70 may comprise a tunnel oven, an infrared lamp, or the like. In the firing portion 70, the solidified layer (porous solidified layer) 76 made porous in the vacuum drying portion 60 is hardened by heating on the hot plate 74. The airtight portion 80 located downstream from the firing portion 70 has a treatment chamber 82 in which the workpiece 1 is placed. The treatment chamber 82 is provided with a flushing device 84 at the upper portion thereof. The flushing device 84 instantaneously emits heat rays to expose the surface of the porous solidified layer (porous insulating layer) 86 to high temperature, thereby melting the surface of the porous insulating layer 86 to cover the pores in the surface (not shown in the FIG.). The flushing device 84 may be replaced with a laser-beam emitter or the like to instantaneously expose the surface of the porous insulating layer 86.

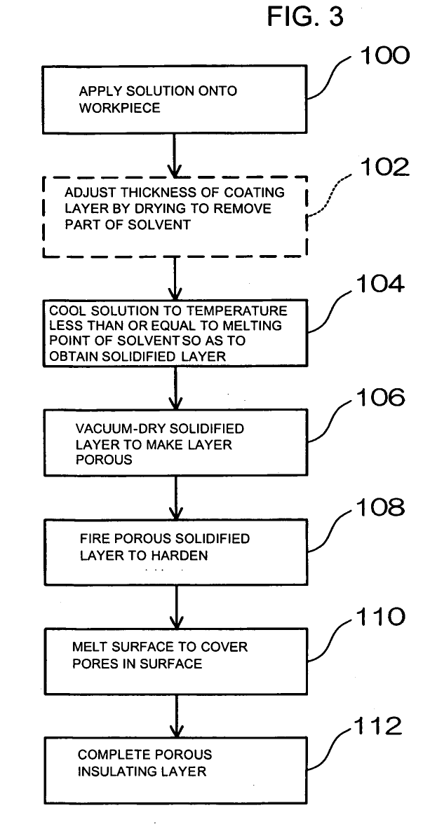

FIG. 3 is a flow chart of a process for forming the porous insulating layer according to the present invention. First, the solution 22 containing an insulating material is applied to the workpiece 1 as shown in step 100 of FIG. 3. The solution 22 contains an inorganic insulating material, such as silicon dioxide or silicon nitride (Si₃N₄) in fine powder form, or an organic insulating material, such as tetraethoxysilane (TEOS) or other alkoxide compounds. The solution 22 preferably has such a property that when the applied solution is cooled to a temperature less than or equal to the melting point of the solvent of the solution 22 to form a solidified layer 68, the solidified layer 68 becomes gel.

In the present embodiment, the application of the solution 22 to the workpiece 1 is performed by slit coating shown in FIG. 2. In the slit coating, the workpiece 1 is put on the bottom surface of the chuck 30 provided at the solution-applying portion 20, as shown in FIG. 2(1). When the capillary 26 serving as an application nozzle is at a standby position (initial position), where the solution 22 is not applied to the workpiece 1, it is located below the surface of the solution 22 in the application liquid bath 24.

For starting the application of the solution 22, the cover 38 is shifted as designated by arrow 120 to release the top opening 36, as shown in FIG. 2(2). The capillary 26 is raised so that the top end (leading end) appears from the top opening 36 as designated by arrow 122, and the chuck 30 is simultaneously shifted toward the capillary 26 as designated by arrow 124. When the leading end of the capillary 26 protrudes from the liquid surface, the solution 22 is drawn up due to a capillary phenomenon allowing surface tension to raise the surface of the solution 22 from the end of the capillary 26.

Then, the vertical position of the capillary 26 is adjusted so as to form a predetermined narrow gap between the capillary 26 and the workpiece 1. The chuck 30 is further shifted as designated by arrow 124 so that the bottom surface of the workpiece 1 comes into contact with the solution 22 raised from the top end of the capillary 26, as shown in FIG. 2(3). The chuck 30 is further shifted as designated by 124 to apply the solution 22 to the workpiece 1, as shown in FIG. 2(4). Thus, a coating layer 126 of the solution 22 is provided on the bottom surface of the workpiece 1. The discharge quantity of the solution 22 from the capillary 26 is controlled by adjusting the vertical position of a solution reservoir communicated with the capillary 26 through a flexible pipe not shown in the FIG. The thickness of the coating layer 126 of the solution 22 is controlled by adjusting the viscosity of the solution 22, the shifting speed of the workpiece 1, and so on. If the bottom surface of the workpiece 30 has asperities to be planarized with an insulating layer, the coating layer of the solution 22 is provided at a thickness sufficient to cover the asperities of the workpiece 30 and to flatten the surface of the coating layer. The solution 22 may be applied at several times.

When the workpiece 1 completely shifts over the capillary 26, the surface of the solution 22 is lowered as designated by arrow 128, as shown in FIG. 2(5), to complete the step of applying the solution 22. Thus, the capillary 26 is moved down to the initial position, as designated by arrow 130 in FIG. 2(6). The cover 38 is shifted as designated by arrow 132 to close the top opening 36. Furthermore, the solution 22 is supplied to the application liquid bath 24 to raise the surface of the solution to its initial position, as designated by arrow 134, so that the capillary 26 sinks in the solution 22. Thus, the discharge hole of the capillary 26 is prevented from clogging.

The workpiece 1 thus provided with the coating layer 126 of the solution 22 is conveyed to a solidified layer-forming step, and the solution 22 is cooled to a temperature less than or equal to the melting point of the solvent of the solution 22, as shown in step 104 of FIG. 3. More specifically, the workpiece 1 is put on the cooling plate 54 in the decompression chamber 62 of the vacuum drying portion 60 shown in FIG. 1. The cooling plate 54, which has been cooled to a predetermined temperature in advance, rapidly cools the coating layer 126 from the workpiece 1 side to a temperature less than or equal to the melting point of the solvent. Thus, the coating layer 126 constituted of the solution 22 is frozen to a solid maintaining its original shape and thickness, thus resulting in a gel solidified layer 68.

If a thin insulating layer with a predetermined thickness cannot be obtained by simply freezing the coating layer 126 due to the viscosity and other factors of the solution 22 used, step 102 is performed to adjust the thickness. Namely, since the thickness of the coating layer 126 decreases corresponding to the vaporized quantity of the solvent, the relationship between temperature and vaporization quantity is obtained in advance for every solvent. Then, the workpiece 1 with the coating layer 126 is allowed to stand at a predetermined temperature for a predetermined time to adjust the thickness of the coating layer 126, and subsequently the workpiece is put on the cooling plate 54 to yield the solidified layer 68 (step 104). Thus, a very thin porous insulating layer can be provided.

After freezing the solution 22 to yield the solidified layer 68, a vacuum drying step is performed in which the decompression chamber 62 is evacuated by a vacuum pump 66 to dry (so called, freeze vacuum dry) the solidified layer 68 under a reduced pressure. Consequently, the solvent vaporizes from the inside of the gel solidified layer 68 to dry the solidified layer 68 by sublimation. Thus, a porous solidified layer 76 whose shape and thickness are maintained is formed (step 106). After vacuum drying for a predetermined time, the workpiece 1 is conveyed to the firing portion to fire the porous solidified layer 76. More specifically, the workpiece 1 is put on the hot plate of the firing portion 70 and the porous solidified layer 76 is heated to a predetermined temperature for a predetermined time to harden the porous solidified layer 76 (step 108). For an insulating material comprising an alkoxide compound, such as TEOS, the compound is thus decomposed, thereby resulting in the silicon dioxide porous insulting layer 86.

The resulting porous insulating layer 86 has a porosity of 90% or more and, accordingly, the dielectric constant can be reduced. However, since the porous insulating layer has a very large porosity, if the thickness of the porous insulating layer 86 is small, the porous insulating layer 86 has an air permeability and reduces the insulating properties with time, due to water trapped from the air or the like. Accordingly, in step 110, the porous insulting layer 86 is subjected to airtight treatment. More specifically, the workpiece 1 having the porous insulating layer 86 is conveyed to an airtight treatment chamber 82 of the airtight treatment portion 80, and the surface of the porous insulating layer 86 is instantaneously exposed to a high temperature with the flushing device 84. Thus, the surface of the porous insulating layer 86 is melted to cover the pores in the surface, so that the air permeability is lost to complete an airtight porous insulating layer (step 112).

As described above, in the method for forming a porous insulating layer according to the present embodiment, the solution 22 containing an insulating material is applied onto the workpiece 1, cooled to a temperature less than or equal to the melting point of the solvent, subjected to so-called freezevacuum drying to make the layer of the solution porous and subsequently subjected to firing to harden it. Thus, the process for forming the porous insulating layer is simplified to reduce treating time significantly. The resulting porous insulating layer 86 has a porosity as extremely large as 90% or more and, accordingly, the dielectric constant can be reduced. Furthermore, since the solution 22 applied onto the workpiece 1 is subjected to freeze-vacuum drying, the asperities of the workpiece can be flattened while the porous insulting layer 86 is formed. In addition, since the solution 22 is applied by slit coating in the present embodiment, the utilization efficiency of the solution 22 can be 96% or more. By applying the method for forming the porous insulating layer according to the embodiment to form an interlayer insulating layer of a semiconductor device or the like, the resulting interlayer insulating layer exhibits a low dielectric constant and, thus, to achieve an electronic device with a high operational speed. If the method for forming the porous insulating layer according to the embodiment is applied to a process for forming an interlayer insulating layer, a planarizaition step by CMP, which is required in the prior art, can be omitted to reduce cost for the electronic device.

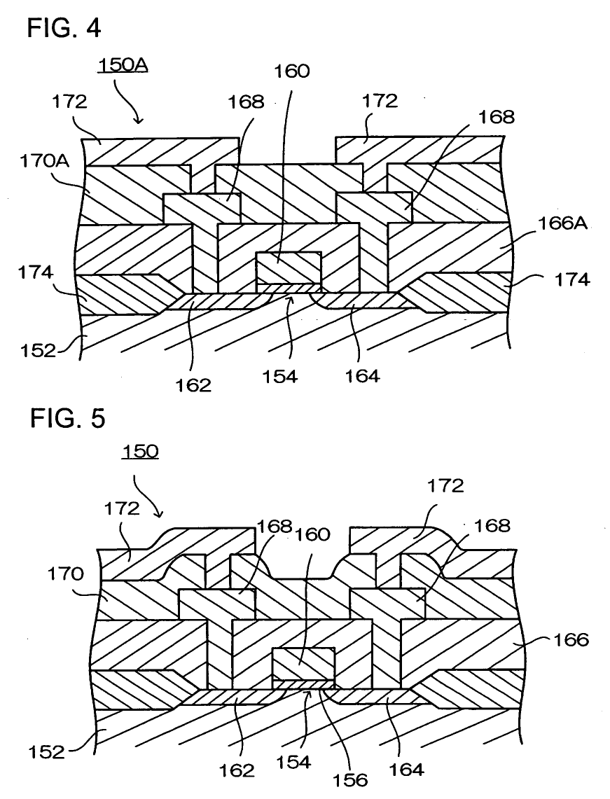

For example, for a semiconductor device (electronic device) 150A shown in FIG. 4, a first interlayer insulating layer 166A covering a MOS transistor 154 is formed in the following manner. First, a field oxide layer 172 and the MOS transistor 154 are formed on a semiconductor substrate 152, in the same manner as in the known method. Then, for example, an alkoxide solution is applied to the entire surface of the semiconductor substrate 152 so as to cover the MOS transistor 154 and the field oxide layer 174. In this case, the thickness of the coating layer of the solution is set so as to cover the unevenness resulting from the presence of the gate electrode 160 and the field oxide layer 172 to flatten the surface of the coating layer. Then, the coating layer of the solution is rapidly cooled to a temperature less than or equal to the melting point of the solvent to be freeze-dried, as described above. Thus, the coating layer is hardened maintaining a uniform state obtained by applying the solution. Then, the coating layer is fired at a predetermined temperature, and, furthermore, airtight treatment is performed by melting the surface of the coating layer, if necessary. Thus, the first interlayer insulating layer 166A is formed. The resulting first interlayer insulating layer 166A does not require planarizaition by CMP because of its flat surface. Thus, the process can be simplified to reduce the time for forming the first interlayer insulating layer.

For the formation of a second interlayer insulting layer 172A, lower wires 168 are formed and, then, for example, an alkoxide solution is applied so as to cover the first interlayer insulating layer 166A and the lower wires 168. The thickness of the coating layer of the solution is set so as to cover the unevenness resulting from the presence of the lower wires 168 to flatten the surface of the coating layer. Then, freeze drying, firing, and airtight treatment are performed, as in above, to yield the second interlayer insulating layer 170A having a flat surface as shown in the FIG. Thus, a planarizaition step by, for example, CMP is unnecessary.

### FIRST EXAMPLE

In benzene (melting point: 5.53° C.), 10 percent by weight of TEOS was dissolved to prepare a solution 22 for application. A semiconductor substrate (workpiece) was slit-coated with the solution 22 by use of the application apparatus shown in FIG. 2. Thus, a coating layer 126 with a thickness of about 200 nm was-formed on the semiconductor substrate. The semiconductor substrate was put on the cooling plate 54 in the decompression chamber 62 and was rapidly cooled to a temperature of −30° C. to change the TEOS benzene solution into a gel solidified layer 68. The decompression chamber 62 was evacuated to about 133 kPa (1 Torr), and the solidified layer 68 was vacuum-dried for 20 hours to yield a porous solidified layer 76. Then, the semiconductor substrate was put on the hot plate 74 and fired at 300° C. for 5 minutes. The resulting porous insulating layer 86 had a thickness of about 200 nm and a porosity of 90% or more. The relative dielectric constant of the porous insulating layer 86 was 1.3. However, in measurement of the relative dielectric constant after 24 hours from the firing, it was found that there was continuity.

### SECOND EXAMPLE

A TEOS benzene solution containing 10 percent by weight of TEOS was prepared, and a porous insulating layer 86 was formed to a thickness of about 200 nm on a semiconductor substrate, as in Example 1. The surface of the porous insulating layer 86 was exposed to a temperature of 800° C. for 10 ms by flushing device 84 for airtight treatment. The relative dielectric constant of the resulting porous insulating layer 86 was 1.3. Also, the relative dielectric constant measured after 24 hours on the following day was 1.3, and was, thus, not changed.

What is claimed is:

1. A method for forming a porous insulating layer, comprising:
the solution-applying step of applying a solution in which an insulating material is dissolved, onto a workpiece;
the solidified layer-forming step of forming a solidified layer by cooling the solution applied onto the workpiece to a temperature less than or equal to the melting point of a solvent contained in the solution;
the drying step of removing the solvent contained in the solidified layer to make the solidified layer porous; and
the firing step of hardening the porous layer obtained by the drying step.

2. The method for forming a porous insulating layer according to claim 1, wherein, in the solution-applying step, the solution is applied so as to cover unevenness of the surface of the workpiece to flatten the surface of the applied layer.

3. The method for forming a porous insulating layer according to claim 1, wherein the drying step is performed under a reduced pressure.

4. The method for forming a porous insulating layer according to claim 2, wherein the drying step is performed under a reduced pressure.

5. The method for forming a porous insulating layer according to claim 1, wherein the solidified layer-forming step is performed after part of the solvent is removed from the solution applied onto the workpiece.

6. The method for forming a porous insulating layer according to claim 1, wherein the firing step is followed by airtight treatment for eliminating the air permeability of the hardened porous solidified layer.

7. The method for forming a porous insulating layer according to claim 1, wherein the solidified layer-forming step is performed by rapidly cooling the solution.

8. The method for forming a porous insulating layer according to claim 1, wherein the application of the solution to the workpiece is performed by silt coating.

9. A porous insulating layer-forming apparatus comprising:
a solution-applying portion for applying a solution in which an insulating material is dissolved, onto a workpiece;
a solidified layer-forming portion for cooling the solution applied onto the workpiece to a temperature less than or equal to the melting point of the solvent contained in the solution to form a solidified layer;
a vacuum drying portion for removing the solvent contained in the solidified layer by decompression to make the solidified layer porous; and
a firing portion for hardening the porous layer obtained in the vacuum drying portion.

10. A porous insulating layer-forming apparatus according to claim 9, wherein the solidified layer-forming portion is provided in a decompression chamber of the vacuum drying portion.

11. An electronic device including a porous insulting layer formed by the method for forming a porous insulating layer according to claim 1.

12. An electronic device including a porous insulating layer formed by use of the porous insulating layer-forming apparatus according to claim 9.
